(19) United States
(12) Patent Application Publication
(10) Pub. No.: US 2007/0104027 A1
(43) Pub. Date: May 10, 2007

(54) TOOL FOR MEASURING PERFORATION TUNNEL DEPTH

(75) Inventor: James E. Brooks, Manvel, TX (US)

Correspondence Address: SCHLUMBERGER RESERVOIR COMPLETIONS, 14910 AIRLINE ROAD, ROSHARON, TX, 77583, US

(73) Assignee: SCHLUMBERGER TECHNOLOGY CORPORATION, Sugar Land, TX (US)

(21) Appl. No.: 11/617,506

(22) Filed: Dec. 28, 2006

Related U.S. Application Data
(62) Division of application No. 11/160,998, filed on Jul. 19, 2005.
(60) Provisional application No. 60/521,923, filed on Jul. 21, 2004.

(51) Int. Cl. G01V 1/00

(52) U.S. Cl. 367/33

(57) ABSTRACT

Various systems and methods are disclosed herein for determining the depth of a cavity in a wellbore using the Helmholtz Effect.

### CROSS-REFERENCE TO RELATED APPLICATIONS

This application is a divisional of U.S. Ser. No. 11/160,998 filed Jul. 19, 2005 which claims the benefit of U.S. Provisional Application Ser. No. 60/521,923, filed Jul. 21, 2004.

### BACKGROUND OF THE INVENTION

1. Technical Field

The present invention relates to the field of perforating. More specifically, the invention relates to tools and methods for measuring the penetration depth of a perforating tunnel.

2. Background

After a well has been drilled and casing has been cemented in the well, one or more sections of the casing, which are adjacent to formation zones, may be perforated to allow fluid from the formation zones to flow into the well for production to the surface or, alternatively, to allow injection fluids to be applied into the formation zones. A perforating gun string (comprising one or more perforating guns) may be lowered into the well to a target depth and the guns fired to create openings in the casing and to extend perforations into the surrounding formation. Production fluids in the perforated formation can then flow through the perforations and the casing openings into the wellbore.

Typically, perforating guns (which may include gun carriers and shaped charges mounted on or in the gun carriers, or, alternatively, a strip of explosive charges) are lowered through tubing or other pipes to the desired well interval. Shaped charges carried in a perforating gun are often phased to fire in multiple directions around the circumference of the wellbore. When fired, shaped charges create perforating jets that form holes in the surrounding casing as well as extend perforations into the surrounding formation.

It is believed, however, that there is no conventional tool or method extant to measure the penetration depth produced by a perforating gun downhole. Generally, the perforations are too remote to measure directly, so it is believed that the only measurement that can be done currently is to estimate penetration using empirically-based models, or to simulate the penetration experimentally using a laboratory model that attempts to reproduce downhole conditions. Unfortunately, empirical models are quite limited in their predictive value and laboratory simulations are expensive, scale-limited, sampling-limited and can suffer from artifacts that have to do with the particulars of the lab setup.

Therefore, it is believed that there is a need in the oil and gas well industry for tools and methods for achieving an in situ measurement of downhole perforation penetration. The present invention is directed at providing such tools and methods of use.

### SUMMARY

In an embodiment of the present invention, a toot for measuring downhole penetrations is provided.

For example, one embodiment of a downhole tool for measuring perforation penetrations may include the following components: an acoustical source and a receiver. These components may be placed across a perforation and operated to create oscillations of a particular frequency within the wellbore. The oscillations may be varied over a range of frequencies until a “characteristic frequency” is evidenced by comparing the source output to the receiver input. The frequency determined is indicative of the length of the perforation.

Some embodiments of the present invention include the following features and objects:

(1) A sonic tool for producing monopole oscillations over a range of frequencies. The source is positioned above (or alternatively below) the perforations. The tool detects transmitted acoustic energy below (or alternatively above) the perforations.

(2) Perforations form cavities in the wall of casing. These cavities have characteristic resonances, which produce large-amplitude motion in the cavity when excited by a sound source in the wellbore casing. These resonances may be detected with a sonic tool by sensing notch attenuation in the transmitted pressure in the wellbore at characteristic frequencies.

(3) The detected characteristic frequency is related to the perforation depth.

While embodiments of the tool and method of the present invention are disclosed for measuring perforation penetration depths, it is intended that the invention is not limited to such downhole use. Other embodiments include measurements of the depths of any penetrations or any set of holes in the side wall of a wellbore.

### BRIEF DESCRIPTION OF THE DRAWINGS

The manner in which these objectives and other desirable characteristics can be obtained is explained in the following description and attached drawings in which:

FIG. 1A illustrates a cross-sectional view of an embodiment of a duct having a Helmholtz cavity.

FIG. 1B illustrates a chart showing the amplification of a particle velocity inside a Helmholtz cavity as a function of the frequency of the noise in the transmitting duct of FIG. 1A.

FIG. 1C illustrates a cross-sectional view of an embodiment of a Helmholtz resonator.

FIG. 2 illustrates a profile view of an embodiment of a perforating gun being used to perforate a target wellbore formation.

FIG. 3 illustrates an enlarged cross-sectional view of a perforating tunnel used as a Helmholtz cavity in accordance with an embodiment of the present invention.

FIG. 4 illustrates a chart showing an example of an attenuation curve as a function of frequency to determine the resonance frequency of a Helmholtz cavity in accordance with an embodiment of the present invention.

FIG. 5 illustrates a profile view of an embodiment of the cavity depth measuring system of the present invention.

FIG. 6 illustrates a chart showing an embodiment of the cavity depth measuring method of the present invention.

It is to be noted, however, that the appended drawings illustrate only typical embodiments of this invention and are, therefore, not to be considered limiting of its scope, for the invention may admit to other equally effective embodiments.

### DETAILED DESCRIPTION OF THE INVENTION

In the following description, numerous details are set forth to provide an understanding of the present invention. However, it will be understood by those skilled in the art that the present invention may be practiced without these details and that numerous variations or modifications from the described embodiments may be possible.

As used herein, the terms “connect”, “connection”, “connected”, “in connection with”, and “connecting” are used to mean “in direct connection with” or “in connection with via another element”; and the term “set” is used to mean “one element” or “more than one element”; the terms “up” and “down”, “upper” and “lower”, “upwardly” and downwardly”, “upstream” and “downstream”; “above” and “below”; and other like terms indicating relative positions above or below a given point or element are used in this description to more clearly describe some embodiments of the invention. However, when applied to equipment and methods for use in wells that are deviated or horizontal, such terms may refer to a left to right, right to left, or other relationship as appropriate. As used here, the terms “up” and “down”; “upper” and “lower”; “upwardly” and downwardly”; “above” and “below”; and other like terms indicating relative positions above or below a given point or element are used in this description to more clearly describe some embodiments of the invention. However, when applied to equipment and methods for use in wells that are deviated or horizontal, or when such equipment are at a deviated or horizontal orientation, such terms may refer to a left to right, right to left, or other relationship as appropriate.

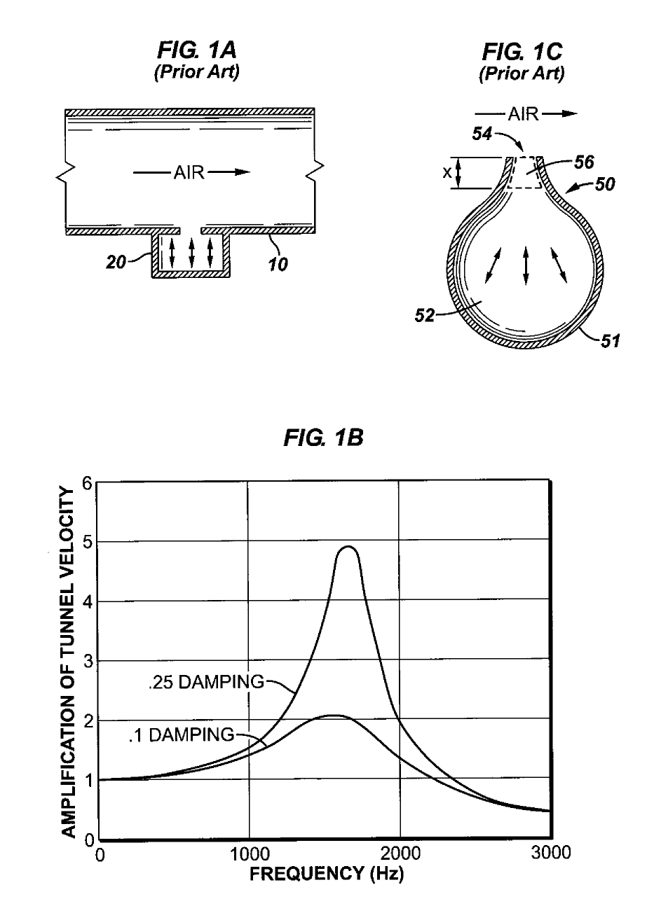

The principle of a penetration measurement tool, in accordance with some embodiments of the present invention, relies on the concept of the Helmholtz Effect, which is sometimes utilized in sound reduction applications (e.g., air conditioning ducts, motors, etc.) to attenuate a noise of a particular frequency. For example, with respect to FIG. 1A, to reduce noise in an air duct 10, a tuned cavity 20 or Helmholtz cavity may be connected to the side of the duct such that air moving into the cavity vibrates in response to the air moving through the duct. The geometry of the cavity 20 is characterized by an effective mass and a stiffness that responds to the vibration in the duct 10. If the cavity geometry is selected properly, then the air in the cavity 20 will oscillate at the frequency of the unwanted noise and thus dissipate the unwanted noise from transmitting down the duct 10. FIG. 1B shows the amplification of a particle velocity inside the Helmholtz cavity as a function of the frequency of the noise in the transmitting duct. The particle velocity has a notable increase in amplitude as it nears a frequency characterized by its dimensions. The exact amplitude near resonance depends on the effective damping of the system.

In another example, a conventional Helmholtz resonator 50 includes a chamber 51 defining an enclosed air space 52 that communicates with an outer space through an opening 54. An air plug 56 present in the opening 54 forms a mass that resonates on support of the spring force formed by the air within the enclosed space 52. The resonance frequency of such a Helmholtz resonator 50 depends on the area of the opening 54, the volume of the enclosed air space 52, and the length x of the air plug 56 formed in the opening. The frequency range and the extent of attenuation may be regulated by changing the dimensions of the chamber 51 that defines the air space 52 and/or by changing the size of the opening 54. If the volume of the air space 52 is increased, then the resonance frequency is shifted toward a range of lower frequencies; and if the volume of the air space is decreased, then the resonance frequency is shifted toward a range of higher frequencies. Likewise, if the area of the opening 54 is decreased, then the resonance frequency is shifted towards a range of lower frequencies, and if the area of the opening 54 is increased, then the resonance frequency is shifted towards a range of higher frequencies.

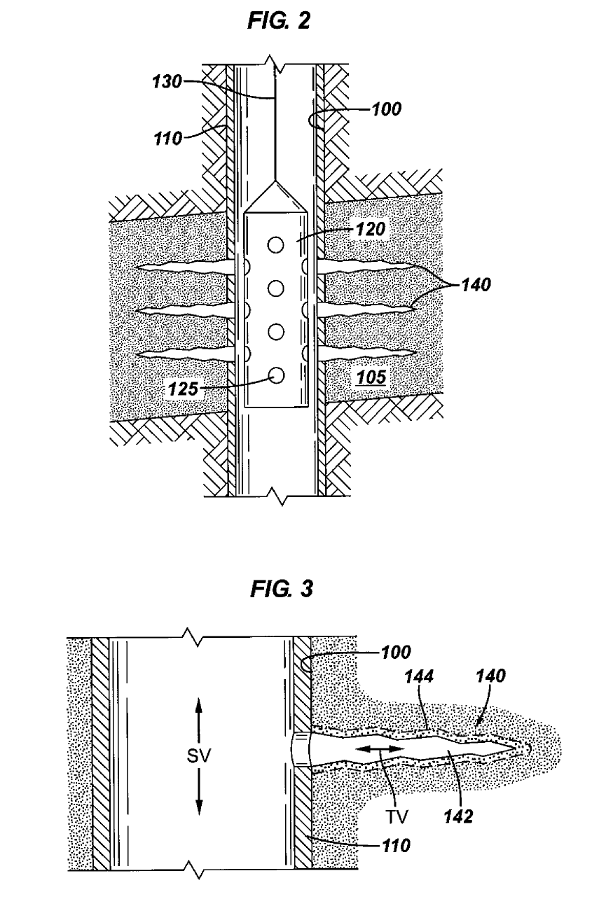

In one embodiment of the present invention, the principle of the Helmholtz Effect is applied to a wellbore with perforations to determine the depth of the perforation tunnels. As shown in FIG. 2, a wellbore 100 filled with a well liquid and having a casing 110 (alternatively, the wellbore may be uncased or open) intersecting a production formation 105 may be perforated to facilitate production of the well. For example, a perforating gun 120 (e.g., a carrier gun, capsule gun, strip gun, and so forth) may be lowered into the wellbore 100 on a carrier line 130 (e.g., wireline, slickline, e-line, coiled tubing, and so forth). The perforating gun 120 includes one or more explosive charges 125 (e.g., shaped charges or capsule charges). The perforating gun 120 is lowered to a target depth such that the explosive charges 125 are adjacent to the target formation 105. At this location, the perforating gun 120 is detonated such that the explosive charges 125 perforate the surrounding casing 110 and penetrate the production formation 105. Such a perforation operation results in the formation of one or more perforation tunnels 140. Typically, a perforation tunnel 140 comprises a tapered cavity 142 surrounded by a layer of crushed formation or “crushed zone” 144 that has been damaged by the explosive charge detonation (as shown in FIG. 3).

With respect to FIG. 3, as with the examples discussed above and shown in FIGS. 1A, 1B, and 1C, the cavity 142 of the perforating tunnel 140 is capable of oscillating if excited at a particular frequency of motion in the wellbore 105. However, instead of an air medium as in the examples above, the medium in the wellbore 100 and cavity 142 is a liquid. For a better understanding, the wellbore 100 is analogous to the duct 10 (of FIG. 1A) and the perforation cavity 142 is analogous to the Helmholtz cavity 20 (of FIG. 1A). An acoustic source may be used to provide an acoustic signal within the wellbore 100 to move the wellbore liquid past the perforation tunnel 140 at a source velocity SV. The wellbore liquid within the cavity 142 of the perforation tunnel 140, if excited near the cavity's characteristic frequency, will act as a Helmholtz resonator. The effect is to create motion of the wellbore liquid within the cavity 142 at a tunnel velocity TV. This movement of wellbore liquid within the cavity 142 can be used to attenuate sound as it propagates in the wellbore 100. Thus, if the acoustic source emits a signal at the resonance frequency of the cavity 142, then the received signal will be attenuated. By monitoring the wellbore 100 for this distinctive attenuation, the resonance frequency of the cavity 142 can be determined (i.e., the resonance frequency will be the frequency of the sound emitted by the acoustic source that causes maximum attenuation in the wellbore). The maximum attenuation depends on the internal dissipation of motion inside the perforation tunnel, which in turn depends on the competency of the tunnel wall and viscosity of the wellbore liquid. For example, the attenuation may be a ratio of source pressure (from acoustic source) above the perforation to received pressure (by acoustic receiver) below the perforations. This ratio may be measured as a voltage response of corresponding transducers.

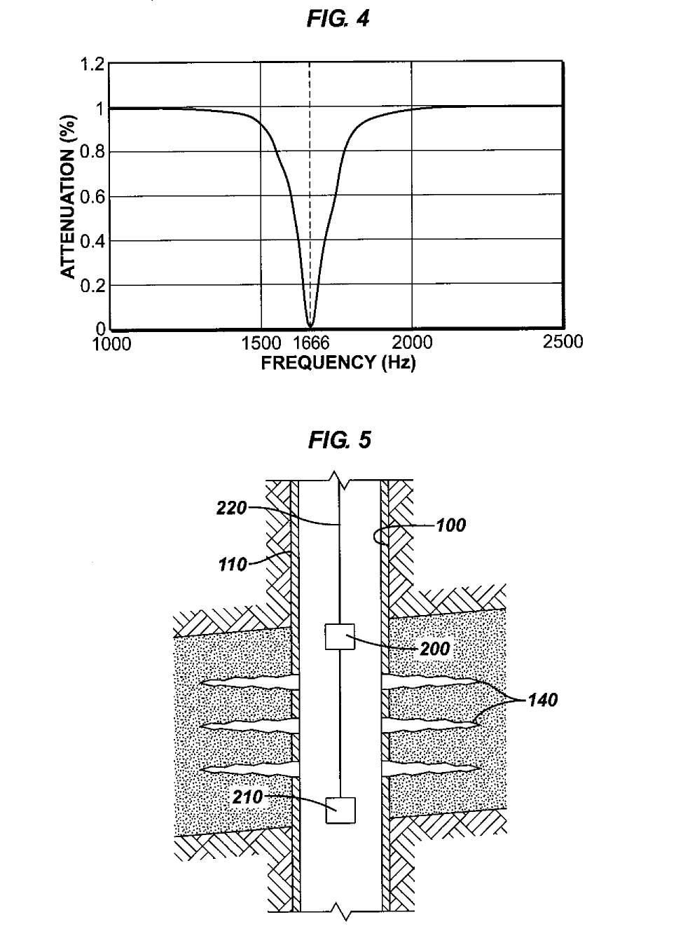

For example, as shown in FIG. 4, the resonance frequency of a perforation tunnel may be 1666 Hz, which is indicated as the frequency value where the attenuation has a distinctive minimum. Once the resonance frequency is determined, the length of the cavity 142 may be substantially calculated mathematically (e.g., using a first order model of an ideal cylindrical cavity). For a cylindrical cavity of length (P), the primary resonance frequency (fp) is given by:
fp=0.25c/P;
where c is the speed of sound traveling through the wellbore liquid. The value of the speed of sound may be determined or otherwise approximated from the identifiable composition of the wellbore liquid, or it may be measured directly using time of arrival information. Thus, in an example where the speed of sound traveling through seawater is known to be approximately 1500 meters per second and the resonance frequency of the perforation tunnel is determined to be 1666 Hz, the length of the cavity of the perforation tunnel may be calculated to be approximately 9 inches (assuming that the cavity of the perforation tunnel is relatively narrow with a constant diameter). The actual frequency may be modified by the viscosity of the water, the porosity and hardness in the wall of the cavity and the shape of the tunnel. In the event that these effects are not negligible, a more sophisticated mathematical model may be employed. For example, a finite element model to determine the relationship between frequency and perforation length may be used. In another example, experimental models may be used to determine the relationship between frequency and perforation length empirically. A series of laboratory tests with a variety of rock materials could be used to establish such an empirical relationship.

In another embodiment, where a plurality of perforation tunnels is being measured, there may not be a single, distinctive characteristic frequency. In such an embodiment, several minimum attenuation measurements at different frequencies may be observed, each corresponding to a different perforation length. The most dominant frequency may be used to determine an average perforation depth.

With respect to FIG. 5, in another embodiment of the present invention, a system for determining penetration depth of a perforation tunnel 140 in a wellbore 100 includes an acoustic transmitter 200 and an acoustic receiver 210. The acoustic transmitter 200 is positioned above (or alternatively below) a perforation tunnel 140 (or set of perforation tunnels) in a wellbore 100; and the acoustic receiver 210 is positioned below (or alternatively above) the perforation tunnel 140 such that it is opposite the acoustic receiver 200. In some embodiments, the acoustic transmitter 200 and acoustic receiver 210 may be connected together via a common communication and/or power line 220 and supported on such a line from the surface (as shown in FIG. 4). In other embodiments, the acoustic transmitter 200 and acoustic receiver 210 are independent of one another. The wellbore 100 may be supported by casing 10 or otherwise uncased or open. The acoustic transmitter 200 may be a monopole source, a dipole source, or may otherwise radiate acoustic signals in any number of directions. Moreover, the acoustic transmitter may be capable of transmitting an acoustic signal at variable frequencies. In some embodiments, the acoustic transmitter/receiver may be a transponder. In other embodiments, the acoustic transmitter/receiver may be a transducer (e.g., a piezoelectric transducer). Such a transducer may include a piezoelectric element that converts electrical signals into mechanical vibrations or acoustic signals (while in transmit mode) and mechanical vibrations or acoustic signals into electrical signals (while in receive mode).

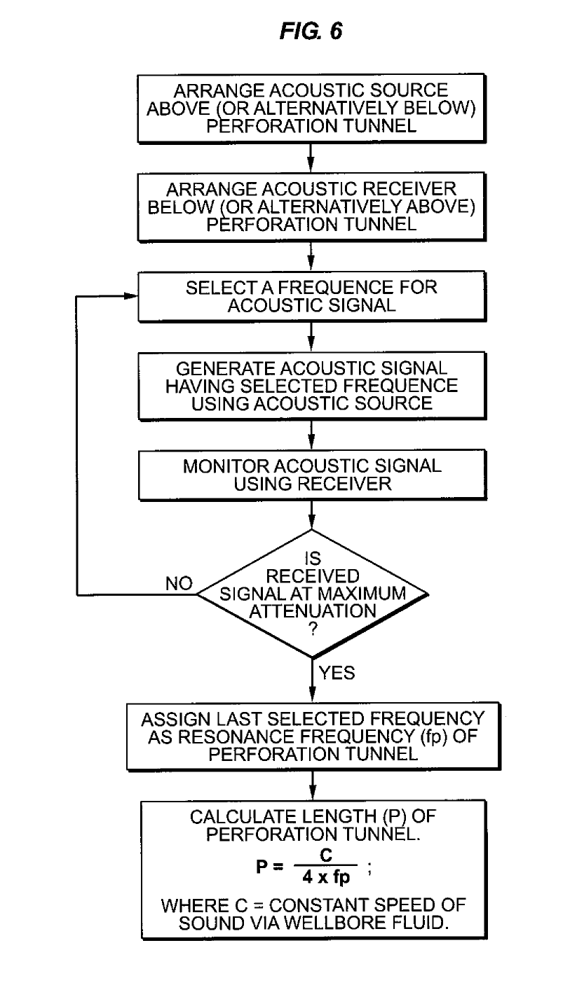

With respect to FIG. 6, in operation an embodiment of the system for determining penetration depth of a perforation tunnel includes providing an acoustic source able to emit an acoustic signal at variable frequencies and an acoustic receiver. The wellbore contains well liquid having a known or determinable value (e) for the speed at which sound travels therethrough. The acoustic source and acoustic receiver are deployed in a perforated wellbore such that the source and receiver are arranged on opposite sides of a perforation tunnel (or set of perforation tunnels) so as to span such tunnel. The acoustic source is actuated to emit a signal of a selected frequency to be received by the acoustic receiver. The frequency of the signal is varied at the source and the receiver is monitored to detect a difference in power (or intensity) of the signal received. As the frequency emitted by the source approaches the resonance frequency of the perforation tunnel, severe attenuation should occur. The resonance frequency (fp) is indicated at the point of maximum attenuation. Finally, the depth of penetration for the particular perforation tunnel may be calculated: P=c/(4*fp).

In other embodiments of the present invention, a transmitter (for emitting an acoustic signal at a predetermined intensity) and a receiver (for receiving the acoustic signal at a receiving intensity) may be connected to a surface controller and monitoring system for measuring the depth of a cavity in a wellbore via a communication and/or power line. The transmitter and receiver may be interconnected by such a line or independently connected to the surface controller and monitoring system. The controller may be used to adjust the frequency and/or the intensity of the acoustic signal emitted by the transmitter. The monitoring system may be used to survey the intensity of the acoustic signal detected by the receiver. In some embodiments, the controller and monitoring system includes a programmable logic controller (PLC) for adjusting the value of the frequency of the emitted acoustic signal and comparing the value of the emitted intensity to the value of the received intensity. The PLC could therefore determine the resonance frequency of the cavity being measured at the point of maximum attenuation, and could use this frequency determination to calculate the depth of the cavity and report this value to an operator at the surface. The PLC may be programmed to achieve such operations (e.g., software). As used herein, the term “surface mechanism” includes any device located at the surface for mechanically supporting, communicating with, powering, controlling, and/or monitoring the transmitter and/or the receiver via a line. In an alternative embodiment, the PLC is located downhole (e.g., embedded in the transmitter or receiver) and the transmitter and receiver are interconnected such that the determination of the resonance frequency of the cavity and the calculation of the depth of the cavity may be performed downhole. In this embodiment, the transmitter and receiver may be connected to a display device at the surface to indicate the calculated depth of the cavity. The connection may be a direct electrical or fiber optic connection, or alternatively a wireless connection (e.g., radio frequency or electromagnetic communication).

In other embodiments the frequency of the acoustic signal emitted by the transmitter may be manipulated directly by an operator and the intensity of the emitted signal may be compared to the intensity of the signal received by the receiver. Once the maximum attenuation is determined, the operator has determined the resonance frequency of the cavity. The operator may then calculate the depth of the cavity in the wellbore. In either of the above-mentioned embodiments, the PLC or operator may calculate the depth of the cavity by the following formula: P=c/(4*fp), where P is the depth of the cavity, c is the speed of sound in the fluid in the wellbore, and fp is the determined resonance frequency of the cavity.

While embodiments of the present invention have been disclosed and illustrated for the purpose of determining the depth of a perforation tunnel in a wellbore, it is intended that the system, tools, and methods described herein may be used for determining the depth of any cavities in a well including, but not limited to, perforation tunnels, cavity of formation, size of formation fracture, and so forth.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims. In the claims means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. An apparatus for measuring depth of a cavity in a wellbore, comprising:
a first transponder adapted to emit an acoustic signal at a selected frequency and a predetermined intensity, the first transponder being arranged on one side of the cavity; and
a second transponder operatively connected to the first transponder and adapted to detect the acoustic signal emitted by the first transponder at a received intensity, the second transponder being arranged on the other side of the cavity opposite the first transponder.

2. The apparatus of claim 1, wherein the first transponder comprises a piezoelectric transducer operating in a transmit mode.

3. The apparatus of claim 1, wherein the second transponder comprises a piezoelectric transducer operating in a transmit mode.

4. The apparatus of system of claim 1 further comprising:
a programmable logic controller operatively connected to the first transponder or second transponder; the programmable logic controller being adapted to: (i) compare the intensity of the acoustic signal emitted by the transponder with the intensity of the acoustic signal received by the second transponder; (ii) regulate the frequency of the acoustic signal emitted by the first transponder; (iii) determine the frequency of the acoustic signal emitted by the first transponder where the intensity of the acoustic signal received is substantially maximally attenuated; and (iv) calculate the depth of the cavity.

5. The apparatus of claim 4, wherein the programmable logic controller is adapted to calculate the depth of the cavity using:
P=c/(4*fp),
where P is the depth of the cavity being calculated, c is the speed of the acoustic signal traveling through the wellbore, and fp is the determined frequency of the acoustic signal emitted by the acoustic source where the intensity of the acoustic signal received is substantially maximally attenuated.
